(19) United States
(12) Patent Application Publication
(10) Pub. No.: US 2026/0300335 A1
(43) Pub. Date: Oct. 1, 2026

(54) SYSTEMS AND METHODS FOR GENERATING FACTUALLY ACCURATE, DIVERSE, AND COMPREHENSIVE TEXT

(71) Applicant: UNIVERSITY OF MASSACHUSETTS, Westborough, MA (US)

(72) Inventors: Alireza Salemi, Amherst, MA (US); Christos Samarinas, Amherst, MA (US); Hamed Zamani, Hadley, MA (US)

(21) Appl. No.: 19/636,326

(22) Filed: Apr. 1, 2026

Related U.S. Application Data
(60) Provisional application No. 63/781,688, filed on Apr. 1, 2025.

(51) Int. Cl. G06F 16/3329; G06F 16/338

(52) U.S. Cl. CPC G06F 16/3329; G06F 16/338

(57) ABSTRACT

Various examples are provided for generating factually accurate, diverse and comprehensive text. In one example, a method for retrieval augmentation in text generation includes generating a set of global exploration plans, each global exploration plan comprising a list of query aspects for creating a response to a query and a corresponding query formulation of each query aspect for retrieving relevant content; retrieving information based upon each of the set of global exploration plans; and generating a detailed response to the query by refining the retrieved information, the accuracy of the detailed response based upon evaluation by a trained reward model, the detailed response rendered for display. The retrieved information can be iteratively refined to generate the detailed response. The reward model can be trained to select a most factual and complete response.

### CROSS REFERENCE TO RELATED APPLICATIONS

This application claims priority to, and the benefit of, U.S. provisional application entitled “Systems and Methods for Generating Factually Accurate, Diverse, and Comprehensive Text” having Ser. No. 63/781,688, filed Apr. 1, 2025, which is hereby incorporated by reference in its entirety.

### STATEMENT REGARDING FEDERALLY SPONSORED RESEARCH OR DEVELOPMENT

This invention was made with Government support under Grant No. 2402873, awarded by the National Science Foundation, Grant No. 2143434, awarded by the National Science Foundation, and Grant No. N000142212688, awarded by the Office of Naval Research. The Government has certain rights in this invention.

### BACKGROUND

Large language models (LLMs) have shown strong performance in text generation by producing fluent, coherent, engaging, and contextually related responses to their input prompts. To address potential hallucination issues and deal with nonstationary and up-to-date information, state-of-the-art question answering systems as well as generative and conversational search engines enhance LLMs through retrieval augmentation, an approach commonly referred to as retrieval-augmented generation (RAG). However, recent studies reveal that the text generated by RAG models can still generate non-factual content, and more importantly, they can lack response diversity and comprehensiveness.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram illustrating an overview of an example of a Plan-and-Refine framework, in accordance with various embodiments of the present disclosure.

FIG. 2 illustrates an example of prompt templates used with the Plan-and-Refine framework of FIG. 1, in accordance with various embodiments of the present disclosure.

FIG. 3 illustrates an example of prompts used by the baselines, in accordance with various embodiments of the present disclosure.

FIG. 4 is a bar chart illustrating an example of the effect of generated plan selection threshold for self-training planner on performance for the ANTIQUE dataset, in accordance with various embodiments of the present disclosure.

FIG. 5 is a graph illustrating an example of the effect of local and global exploration steps the on Plan-and-Refine performance for the ANTIQUE dataset, in accordance with various embodiments of the present disclosure.

FIG. 6 is a bar chart illustrating an example of the effect of generation budget on the performance of Plan-and-Refine on the ANTIQUE dataset, in accordance with various embodiments of the present disclosure.

FIGS. 7A and 7B illustrate an example of a case study on generated plans, responses, and edited responses by the Plan-and-Refine, in accordance with various embodiments of the present disclosure.

FIG. 8 is a schematic diagram illustrating an example of a computing (or processing) device that can be used for the Plan-and-Refine framework or other applications, in accordance with various embodiments of the present disclosure.

### DETAILED DESCRIPTION

Disclosed herein are various examples related to generating factually accurate, diverse and comprehensive text. Various aspects of a Plan-and-Refine (P&R) framework based at least in part on a two phase system design are presented. In the global exploration phase, P&R can generate a diverse set of plans for the given input, where each plan can comprise a list of diverse query aspects with corresponding additional descriptions. This phase can be followed by a local exploitation phase that generates a response proposal for the input query conditioned on each plan and iteratively refines the proposal for improving the proposal quality. Finally, a reward model can be employed as a utility function to select the proposal with the highest factuality and coverage scores. Experiments were conducted based on the ICAT evaluation methodology—a recent approach for answer factuality and comprehensiveness evaluation. Experiments on the two diverse information seeking benchmarks adopted from non-factoid question answering and TREC search result diversification tasks demonstrate that P&R can significantly outperform baselines, achieving up to a 13.1% improvement on the ANTIQUE dataset and a 15.41% improvement on the TREC dataset. Furthermore, a smaller scale user study confirmed the substantial efficacy of the P&R framework. Reference will now be made in detail to the description of the embodiments as illustrated in the drawings, wherein like reference numbers indicate like parts throughout the several views.

Accurate, diverse, and comprehensive responses are important for applications such as non-factoid question answering, exploratory search, information seeking in domains such as healthcare, legal assistance, education and research, and information-driven decision making systems. Embodiments of the present disclosure can bridge this gap by developing methods with the following defined desiderata: (1) diversity and comprehensiveness: LLM responses should address all diverse aspects of the input, and (2) factuality: claims made in the LLM responses about each aspect should be factually accurate. While the concept of novelty and diversity in retrieval results has been explored within the information retrieval community, training LLMs and RAG systems to generate diverse and comprehensive responses is relatively underexplored.

State-of-the-art open-source and proprietary LLMs not only sometimes generate non-factual content, but also usually do not perform well in generating diverse and comprehensive responses, even if they are specifically asked to in their prompts. This observation has also been validated in the experiments described herein. It was also observed that diversifying the retrieval results in the RAG pipelines do not improve response coverage and completeness. This deficiency in generating comprehensive and factual responses arises from several factors. First, the pre-training objectives for sequence-to-sequence models and post-training techniques are not specifically designed to encourage the generation of diverse outputs. It was observed that techniques like Chain-of-Thought (CoT) prompting that perform well in mathematical reasoning tasks, can fall short in improving response diversity and completeness. Second, the prevalent autoregressive generation paradigm, which relies on greedy decoding or sampling-based token selection, is inherently limited. It tends to favor locally optimal token predictions, often overlooking factual and comprehensive completions that diverge from the initial token prefix. This token-by-token generation process can exacerbate the influence of early poor token choices, potentially distorting the response structure and leaving critical elements inadequately addressed.

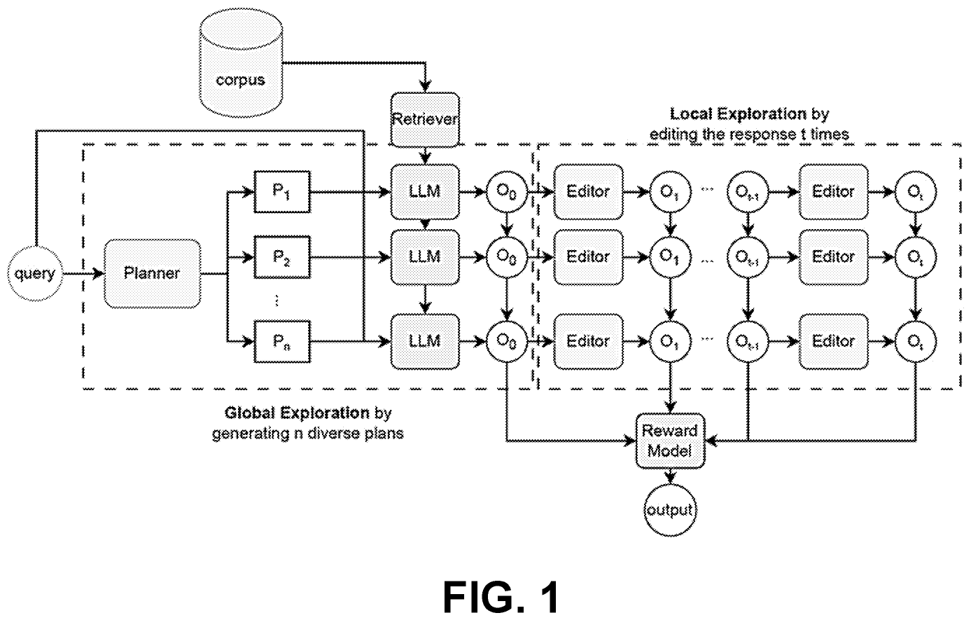

The Plan-and-Refine (P&R) framework is introduced in various embodiments herein to address both of these issues. P&R is generic and can be applied to any RAG pipelines, regardless of their retrieval, reranking, and generation approaches. An overview of this framework according to various embodiments is presented in FIG. 1. The framework can comprise two main phases. The first phase is referred to as “planning”, which generates a set of diverse plans for global exploration. Each plan can include a list of diverse query aspects that are important for creating a comprehensive response to the query, the reasoning behind the value and relevance of each aspect, and the corresponding query formulation of each aspect for retrieving diverse and relevant content. A diverse set of plans can be created by a planner that is optimized via self-training, enabling it to identify diverse key aspects and later structure comprehensive responses effectively. Using each generated plan and the retrieved information for each reformulated aspect query in the plan, an LLM can generate a detailed response to the query. Therefore, each plan results in a potential response for the query. This global exploration phase can be followed by a refining phase as local exploitation. This second phase can refine the LLM response multiple times to improve its comprehensiveness and factuality conditioned on the given plan. Finally, P&R can utilize a trained reward model to evaluate all the generated refinements. The reward model can select the refinement with the highest factuality and coverage, ensuring the final output provides the most accurate and comprehensive answer to the input query.

The experiments described herein were conducted on two diverse information seeking tasks that benefit from comprehensive responses. In the first set of experiments, ANTIQUE—the largest non-factoid question answering dataset with complete manual relevance judgments—was adopted. In the second set of experiments, the description queries in the TREC Web Track data from 2009 to 2012 were adopted, which is based on ClueWeb09 English documents. TREC Web Track ran a successful search result diversification task during this period, meaning that the queries in the dataset have multiple aspects and benefit from diverse perspectives. The recent ICAT evaluation methodology was used for evaluating factuality and information coverage in the generated text in response to queries in these datasets. The results demonstrate that the P&R framework outperforms a competitive and diverse set of open-source and proprietary baselines across both datasets, achieving a statistically significant relative improvement of 13.1% on the ANTIQUE dataset and 15.4% on the TREC datasets. A small user study was conducted to demonstrate user's preferences over the best baseline model. It was observed that in 63% of cases, annotators prefer P&R's responses over the ones produced by the best performing RAG baseline with the same LLM.

Retrieval-Augmented Generation. RAG is a framework that integrates information retrieval and natural language generation to enhance the quality and relevance of generated content by incorporating external knowledge during the generation. In contrast to traditional LLMs that rely solely on knowledge acquired during pre-training, RAG systems retrieve information from external knowledge bases using a retriever, allowing them to produce contextually and factually accurate outputs. The versatility of RAG makes it applicable to various domains, including knowledge-grounding in textual and multimodal, personalization, and reducing hallucinations in generated content. RAG was used herein to enhance factuality and coverage of responses generated by LLMs.

Planning & Reasoning in Text Generation. Addressing complex problems can often involve breaking them down into smaller subproblems and solving each independently. This process can be viewed as planning a sequence of simpler steps to tackle a larger challenge. These subproblems may, in turn, require reasoning to solve effectively. Reasoning refers to a model's capability to process information step-by-step, often referred to as chain-of-thought (CoT) reasoning. CoT reasoning enhances the performance of large language models (LLMs) on tasks requiring mathematical, logical, and commonsense reasoning. This reasoning ability has recently been applied in areas such as evaluation, code generation, improving alignment, and personalization. Research on reasoning in free-form text generation has been relatively limited, focusing primarily on logical and complex reasoning tasks. However, recent studies have demonstrated its effectiveness in generating high-quality free-form text, including tasks requiring emotional and personalized generation. The use of planning with reasoning can improve comprehensiveness and factuality of generated responses by LLMs.

Diversity & Coverage in Text Generation. Diversity and coverage have been studied in the retrieval community, with several TREC tracks dedicated to these topics. Traditionally, these concepts have been approached as syntactical problems in text generation, where diversity is often evaluated based on the variety of words and phrases using n-gram metrics, with less attention given to content diversity. Consequently, much of the focus has been on improving syntactical diversity. Recently, the TREC RAG track has also introduced the concept of evaluating text generation coverage through Nuggets. However, judgments on this aspect are not yet publicly available. In parallel, ICAT has been introduced as a metric that evaluates diversity, completeness, and factuality of generated responses based on their content rather than syntax. The present disclosure focuses on enhancing the diversity, coverage, and factuality of LLM-generated outputs specifically in terms of content.

Scaling Test-Time Compute. Recent advancements in the reasoning capabilities of LLMs for logical and mathematical tasks have demonstrated that increasing the compute budget during the inference phase can be an effective approach to improve performance. This method can allow LLMs to utilize additional inference resources to explore the response space, enabling them to provide more accurate answers for tasks such as logical reasoning, mathematical problem-solving, and code generation. While this concept has been examined in domains such as math, code, and logical reasoning, its use in free-form text generation remains relatively unexplored. The present disclosure extends this approach to free-form text generation, utilizing increased inference compute to search the response space more effectively and generate responses that are more comprehensive and factual for a given prompt.

Problem Formulation. A generative language model M_{G} takes a prompt x and produces y̅ as the response. The quality of the generated output can be assessed based on various factors: coherence, factual accuracy, relevance, fluency, and alignment. One aspect that has received relatively little attention is comprehensiveness while maintaining factuality. In this context, the response should offer a comprehensive and thorough coverage of topics related to the input x, ensuring the output remains factually accurate and minimizes hallucinated or incorrect information based on a reference knowledge corpus C. This corpus can take various forms: unstructured text, an encyclopedia, or even the entire web. The only requirement is that it must be a trusted source of information. A goal of the present disclosure is to enhance the capability of LLMs to generate responses that are both highly factual and comprehensive. This quality is assumed to be quantifiable using a utility function or evaluation metric μ. Specifically, ICAT is employed as the evaluation metric to assess the coverage of diverse factual information in long-form text generation. The present disclosure focuses on improving the ability of LLMs to achieve higher ICAT scores, thus advancing the quality of their output in terms of coverage of diverse factual information. The present disclosure assumes access to a set of training queries that benefit from comprehensive and diverse responses

$$Dtrain = {\{ {x}_{i} \}}_{i = 1}^{\vert {D}_{train} \vert}$$

and a set of validation queries

$$Dtest = {\{ {x}_{i} \}}_{i = 1}^{\vert {D}_{test} \vert} ,$$

both comprise input prompts without any corresponding reference outputs. Such queries can be obtained from non-factoid question answering datasets, community question answering websites, and discussion forums. In this setup, methods are proposed to improve μ in a reference-free setting, where no ground truth labels are available.

The P&R Framework. Ensuring accurate and complete LLM responses is important to prevent misinformation, cover key aspects of prompts comprehensively, and build user trust. As discussed previously, prior research highlights that LLMs struggle to consistently produce complete and accurate responses. Even very capable models like GPT-4 cover less than 50% of relevant subtopics on average for a given prompt. Furthermore, while RAG enhances factuality, it is shown to reduce the coverage of generated responses (as detailed below). Several factors can contribute to this deficiency in LLMs. Current pre-training sequence-to-sequence and post-training objectives do not effectively encourage factual and comprehensive responses. Even techniques like Chain-of-Thought prompting, designed for mathematical reasoning, fail to improve response completeness. Moreover, the token-by-token text generation approach, whether greedy or sampled, is sub-optimal. It can often overlook factual and complete responses that deviate from the prefix of generated tokens, leading to incomplete outputs. In essence, the LLM's initial token selection influences output structure, causing key aspects to be missed or underrepresented.

A straightforward solution to these issues could be to explicitly ask LLMs to generate complete and factual responses that consider all aspects of the question. Furthermore, post-training techniques such as RLHF or Self-Training can be used to optimize a reward model or metric that accounts for the completeness of the response. However, these approaches do not address the inherent problem of sampling responses from LLMs, where the structure of the output can still be influenced by the initial tokens, potentially leading to incomplete or inaccurate responses. To address the two aforementioned challenges, P&R, a novel approach that can first generate a set of plans outlining the aspects that need to be covered, is introduced along with the rationale about why each aspect is important for ensuring a complete and factual response to the prompt and the query to retrieve information about each aspect. The model can then generate responses based on each plan and retrieved documents and iteratively refine them through multiple editing steps. Finally, a reward model can be employed to select the response with the highest score as the final output. The following subsections provide a detailed explanation of this approach.

Overview. The overview of P&R according to various embodiments is shown in FIG. 1. The present disclosure assumes the existence of a planner model Mₚ(x) that takes the input prompt x and returns a plan p for generating factual and complete responses to the prompt. The plan

$$p = {\{ ( {a}_{i} , {q}_{i} , {r}_{i} ) \}}_{i = 1}^{\vert p \vert}$$

comprises a set of aspects aᵢ about the prompt, a query qᵢ to gather information about the respective aspect, and a reason rᵢ explaining why this aspect is important for generating a complete and factual response to the prompt x. The present disclosure assumes the existence of a retrieval model R and a retrieval budget k to collect the necessary information for improving the factuality of the claims in the response. To gather the necessary information for executing a plan p, for each (aᵢ, qᵢ, rᵢ)∈p, k/|p| documents are retrieved for the query qᵢ from the corpus C. The retrieved documents form the context

$${I}_{p} = {⋃}_{( {a}_{i} , {q}_{i} , {r}_{i} ) ∈ p} R ( {q}_{i} , \frac{k}{\vert p \vert} , C )$$

that can be used during response generation. The present disclosure assumes the existence of a generative model M_{G}(x, p, Iₚ) that, given a prompt x, a plan p, and the associated context Iₚ, generates an output response oₚ to the prompt x with the given plan p as the steps it should take. To explore diverse solutions to the problem, n distinct plans are sampled using the planner model M_{P}, resulting in a set of plans P={pᵢ}ᵢ₌₁ⁿ. These plans provide a range of strategies that can be utilized to address the problem effectively. This step can be seen as sampling and searching through the space of all potential solutions to the problem, a process referred to as Global Exploration. Then, the generative model M_{G} is applied to each plan p∈P, producing an initial set of proposed responses O₀={M_{G}(x, p, Iₚ)|p∈P}.

While global exploration generates a diverse set of solutions to the prompt, it often falls short in meeting specific requirements with precision. To address this, the present disclosure introduces the concept of Local Exploitation, which focuses on refining these solutions through targeted adjustments. This approach enhances and ensures higher quality responses. For this, the present disclosure assumes the existence of an editing model M_{E} that, given the input prompt x, a plan p, and a previously generated response oₜ₋₁ for this prompt and plan, improves the response to generate oₜ=M_{E}(x, p, oₜ₋₁). Using this iterative approach, the present disclosure can refine the initial set of generated responses. At each step, the updated responses are represented as Oₜ={M_{E}(x, p, oₜ₋₁)|oₜ₋₁∈Oₜ₋₁, p∈P}. By repeating this editing process T times, a final set of response proposals are obtained, denoted as

$${O}_{F} = {⋃}_{t = 0}^{T} {O}_{t} ,$$

which encompasses all the initial set of responses and refined outputs generated in iterations. Finally, to identify the most suitable response among all proposed candidates, a mechanism is employed to select the one that best meets the prompt's requirements, prioritizing completeness and factuality—key objectives of this problem. The present disclosure assumes the existence of a reward model M_{R}(x, o) that assigns a score to each generated output o∈O_{F} based on the input prompt x. The final response to the prompt is selected as the output that achieves the highest score according to the reward model, formally as: o_{f}=arg max_{o∈O}_{_{F}}M_{R}(x, o). This ensures the chosen response is the most complete and factual among the generated candidates.

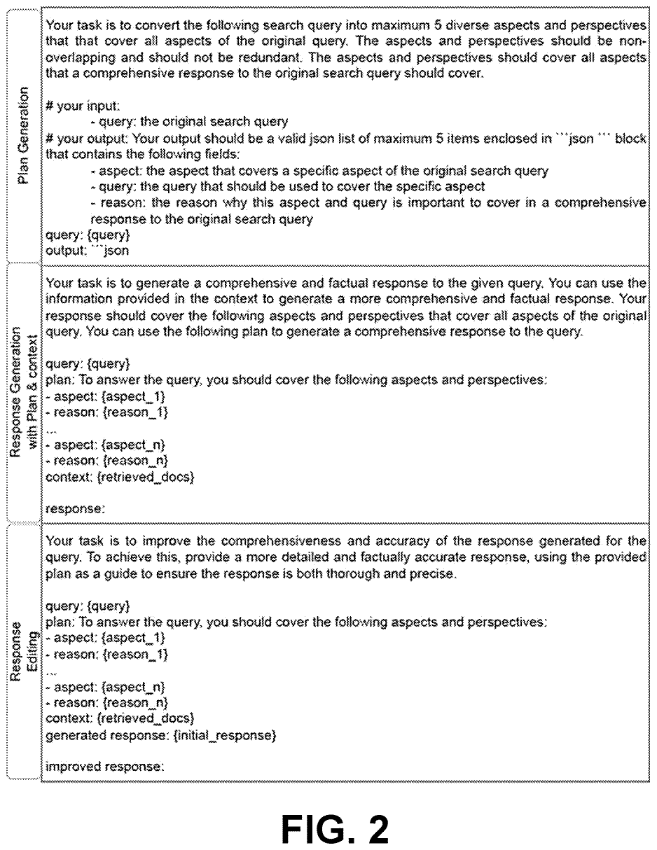

Global exploration through planning. The present disclosure defines a plan for responding to a prompt x as a set of steps, each comprising three key components: 1) a title that identifies an aspect to be addressed in order to provide a complete and factual response, 2) a justification or reasoning that explains why this particular aspect is important and how it contributes to addressing the prompt effectively, and 3) a retrieval query designed to gather relevant information about the specified aspect from an external corpus. To obtain a plan, the present disclosure samples it from a planner model M_{P}, which is an LLM guided by the plan generation prompt shown in FIG. 2. This prompt is designed to guide the LLM to analyze the given input x and generate the aspects that should be included in a complete and factual response, in the expected format. Next, using the queries specified in the generated plan p, the retrieval model R is employed within a defined retrieval budget k to gather a supporting context. Specifically, for each component (aᵢ, qᵢ, rᵢ)∈p, k/|p| documents are retrieved from the corpus C. The resulting context for the plan p is denoted as

$${I}_{p} = {⋃}_{( {a}_{i} , {q}_{i} , {r}_{i} ) ∈ p} R ( {q}_{i} , \frac{k}{\vert p \vert} , C ) .$$

To produce a response for the prompt x, the generative model M_{G} is leveraged. This model, which is an LLM, takes the input x, the generated plan p, and the corresponding context Iₚ to generate a response. The process uses the “response generation with plan and context” prompt, as illustrated in FIG. 2. This prompt guides the model to incorporate the generated aspects and their associated reasoning from the plan, along with the provided context, to produce a comprehensive and factual response.

To sample a plan from Mₚ, various strategies can be employed. The most common is greedy sampling, which returns the most probable plan for the given input x. While effective, the most probable plan may not always yield the most complete and factual response. Alternatively, nucleus sampling, which introduces randomness, can generate diverse plans but risks reducing performance when only one plan is sampled. To balance these trade-offs, various embodiments of the present disclosure sample N plans using high-temperature nucleus sampling, denoted as P={pᵢ|pᵢ~M_{P}(x), for i=1, . . . , N}. This allows exploration of multiple potential strategies for addressing x, effectively conducting a global search across the response space to identify diverse and potentially better plans for response generation. Finally, for each plan p∈P, the generative model M_{G} is used to generate a response. This results in an initial set of responses, denoted as O₀={M_{G}(x, p, Iₚ)|p∈P}, serving as the starting point for further refinement and selection in response to the input x.

Optimization. To optimize this step, Self-Training was employed as the optimization approach. Importantly, during this process, the present disclosure only optimizes the planner model M_{P}, while keeping the generative model M_{G} frozen. For this purpose, for each input x∈Dₜᵣₐᵢₙ, the present disclosure samples B=32 plans using a high temperature τ=0.7. A response is then generated for each plan and its corresponding context. To select high-quality plans that resulted in high-quality responses, the evaluation metric μ is used and only those plans that their corresponding responses achieved a score higher than the input-dependent threshold ax were retained, as follows: Dₚₗₐₙ={(x, p)|x~Dₜᵣₐᵢₙ; p~M_{P}(x); μ(x, M_{G}(x, p, Iₚ))≥αₓ} to form the training dataset Dₚₗₐₙ for training the planner model. The αₓ parameter was then set based on the score of the generated responses. Specifically, αx is chosen as the score corresponding to the top Z-percentile of the generated responses (z=95 was used by default, unless otherwise noted). This ensures that only the highest-scoring responses, as determined by the evaluation metric μ, are retained for training the planner model. Finally, the planner was trained using a sequence-to-sequence loss function with Dₚₗₐₙ, where for each (x, p)∈Dₚₗₐₙ the model generates the plan p as the output for the input x.

Local exploitation through refining. While global exploration generates a diverse set of solutions to the prompt, it often lacks the precision required to meet specific requirements. In fact, it was observed that refining the response generated by a plan, using the same plan, leads to improved results. This suggests that focusing on enhancing existing solutions rather than exploring new ones can also yield to more accurate and complete responses to the prompt. This iterative process of improving the response generated for a prompt x by a plan p, using the same plan and refining the solution based on previous outputs, can be viewed as a local exploitation over the response space. Unlike global exploration, where both the plan and the output can vary, in local exploitation, the plan—the general instruction for the model in responding to the prompt—remains the same. It is the output that evolves through successive edits, refining the response according to the same guiding plan. To perform iterative refinement, the editing model M_{E} was used, an LLM that uses the response editing prompt shown in FIG. 2. The model takes the input x, the plan p, and the previous output oₜ₋₁ generated using this plan as input, and produces the refined output oₜ=M_{E}(x, p, oₜ₋₁). This iterative process allows refinement of the initial set of responses O₀ from the global exploration phase. At each step, the updated responses are represented as Oₜ={M_{E}(x, p, oₜ₋₁)|oₜ₋₁∈Oₜ₋₁, p∈P}. By repeating this editing process T times, a final set of proposals are obtained, denoted as

$${O}_{F} = {⋃}_{t = 0}^{T} {O}_{t} ,$$

encompassing both the initial responses and the refined outputs after each editing step generated through the iterative steps. Therefore, the final response to the input x can be selected from the set of proposed responses O_{F}, resulting from both global exploration using diverse plans and multiple rounds of local exploitation through iterative editing of responses.

Optimization. To optimize the editing model M_{E}, a plan p was first sampled from the optimized planner model M_{P} for each input x∈Dₜᵣₐᵢₙ. For each plan p, B=8 pairs of outputs were generated from the generative model M_{G} using a high sampling temperature τ=0.7. These pairs are selected such that the difference in their scores, as evaluated by the metric μ, is at least β. This ensures that the training dataset for M_{E} includes meaningful differences in response quality, so the model can learn how to improve the previous response and generate a new one. Then, the training dataset D_{edit} was formed for training the editing model M_{E} as: D_{edit}={(x, p, o₀, o₁)|x~Dₜᵣₐᵢₙ; p~M_{P}(x); o₀, o₁~M_{G}(x, p, Iₚ); μ(x, o₁)−μ(x, o₀)≥β} where β=0.1. To optimize the editing model M_{E}, the sequence-to-sequence loss function was employed. For each training example (x, p, o₀, o₁)∈D_{edit}, the model takes the input x, the plan p, and the lower-quality output o₀ as input and is trained to generate the higher-quality output o₁. This objective aligns the editing model's predictions with outputs that demonstrate improved quality, as defined by the evaluation metric μ.

Response selection through ranking. Global and local exploitation steps produce a set of proposed responses O_{F}, rather than a single response. To generate a final response o_{f} to the prompt x, a selection mechanism is required to identify the most suitable response. For this purpose, a reward model M_{R} was used, which evaluates each candidate response based on the prompt x and assigns it a score between 0 and 1. To implement M_{R}, a text encoder model Enc was employed. The reward model computes the score as follows: M_{R}(x, o)=σ(Enc([x. o])·W) where W∈ [symbol] ^{d×1} is a trainable weight matrix, d represents the dimension of the encoder's output representations, σ is the sigmoid activation function, and [.] is the concatenation with separate token function. ModernBERT-base was used as the encoder for the reward model. This formulation allows M_{R} to evaluate the relevance and quality of a response o to the prompt x, enabling the selection of the final response o_{f} as: o_{f}=arg max_{o∈O}_{_{F}}M_{R}(x, o).

Optimization. To optimize the reward model M_{R}, a training dataset was constructed by sampling B=8 pairs of plans p₀ and p₁ from the optimized planner model M_{P} with a high temperature τ=0.7 for each input x∈Dₜᵣₐᵢₙ. The corresponding outputs o₀=M_{G}(x, p₀, Iₚ_{₀}) and o₁=M_{G}(x, p₁, Iₚ_{₁}), generated using the generative model M_{G}, are included in the dataset if the difference in their evaluation scores μ(x, o₁)−μ(x, o₀) is at least γ. Formally, the training dataset for reward model is defined as: D_{reward}={(x, o₀, o₁)|x~Dₜᵣₐᵢₙ; p₀, p₁~_{P} (x); o₀~M_{G}(x, p₀, Iₚ_{₀}); o₁~M_{G}(x, p₁, Iₚ_{₁}); μ(x, o₁)−μ(x, o₀)≥γ} where γ=0.1. To train the reward model M_{R}, the following loss function was minimized:

$$L = \begin{matrix}𝔼 \\ ( x , {o}_{1} , {o}_{1} ) ∼ {D}_{reward}\end{matrix} [ - log ( σ ( {M}_{R} ( x , {o}_{1} ) - {M}_{R} ( x , {o}_{0} ) ) ) ]$$

where σ is the sigmoid function. This pairwise loss function is designed to ensure that the reward model assigns higher scores to preferred outputs relative to less preferred ones, as determined by the evaluation metric μ. By enforcing this, the model learns to differentiate between higher-quality and lower-quality responses, aligning its predictions with the preferences encoded in μ.

### Experiments

Datasets. ANTIQUE, a retrieval dataset designed for non-factoid question answering, and TREC Web Track Diversity tasks from 2009 to 2012 were used. These datasets do not include predefined gold responses to questions, but provide a corpus containing the necessary information to answer them. The ANTIQUE dataset comprises 2,426 training questions and 200 test questions. As a pre-processing step, documents with fewer than 50 words were filtered out from the corpus to ensure the quality and richness of the documents used as the knowledge source. This document filtering process resulted in a corpus of 97,327 documents. For the TREC Web Track Diversity tasks, there is no training dataset available, but the query set comprises 200 queries. Queries that seek information about a specific webpage (navigational) were excluded, reducing the set to 179 queries. For the corpus, the ClueWeb09 corpus was used. This dataset was only used to evaluate the P&R framework under the zero-shot setting, as it does not include any training query set. It is important to note that the recently introduced TREC RAG track has proposed the concept of Nugget evaluation for assessing coverage in responses. However, since the judgments are not publicly accessible yet, they were not used.

Evaluation. The factuality and coverage of the generated responses were evaluated using the ICAT metric, which is specifically designed for this purpose. ICAT offers three levels of annotation for evaluating responses: 1) ICAT^{M}: Requires a predefined set of subtopics for each query, along with annotations specifying which subtopics are addressed by each document in the corpus, 2) ICAT^{S}: Similar to ICAT^{M}, but leverages an LLM to determine which subtopics are covered by a document, eliminating the need for manual document-level annotations, and 3) ICAT^{A}: Extends ICAT^{S} by using an LLM to generate the subtopics for a query, removing the dependency on predefined subtopic annotations. ICAT also employs natural language inference (NLI) to fact-check the claims in the generated response. The final score is calculated using the Fmeasure, balancing the factuality of the response with its coverage of the subtopics. For the LM backbone, an instruction-tuned LLama 3.1 model with 8 billion parameters was used. For extracting atomic claims, the trained version of this model provided by ICAT was leveraged. For NLI and fact verification, a trained DeBERTa v3 model suggested by ICAT was employed. As the knowledge source, the corresponding corpus was used in each of the evaluation datasets, i.e., the ANTIQUE corpus and the ClueWeb09-Category B English corpus for the TREC Web Track queries. Spam documents were removed from the ClueWeb corpus using the Waterloo Spam Scorer with the 70% threshold.

Training & Inference Configurations. The Adam optimizer with a learning rate of 5×10⁻⁵ was used for training the LLMs and 1×10⁻⁵ for training the reward model. Gradient clipping is applied with a value of 1, and the training is conducted for a maximum of 2000 steps. A warmup phase is set for 2.5% of the training steps, following a linear learning rate scheduler. Models are evaluated every 100 steps using 10% of the training set as a randomly sampled validation subset, and the checkpoint with the best performance is selected. The combined maximum input and output length were set to 4096 tokens. The instruction-tuned Gemma v2 with 2 billion parameters was used as the LLM and ModernBERT-base with 150 million parameters was used as the reward model. The batch size for all experiments is set to 64. Experiments use 4 NVIDIA A100 GPUS (80 GB VRAM) and 128 GB of RAM. For sampling from the generative model M_{G}, nucleus sampling with a temperature of τ=0.1 was used. For the editing model M_{E}, nucleus sampling is applied with τ=0. When sampling plans with the planner M_{P}, a nucleus sampling temperature of τ=0.7 was used for global exploration and τ=0 otherwise. The exploration budget was defined as the total number of responses generated and edited during the process of responding to an input. N=4 global and T=4 local exploitation steps were performed to achieve a total generation budget of 16, unless stated otherwise. As a retriever, a BERT model pre-trained on retrieval tasks was used. For indexing, the Faiss library was employed to construct a hybrid IVF-HNSW index for ANTIQUE and a flat index for TREC, chosen based on the corpus size. The total retrieval budget for P&R is set to k=40 for the ANTIQUE dataset and k=5 for the TREC dataset. These are chosen based on the document length in each corpus and the context size of the LLMs.

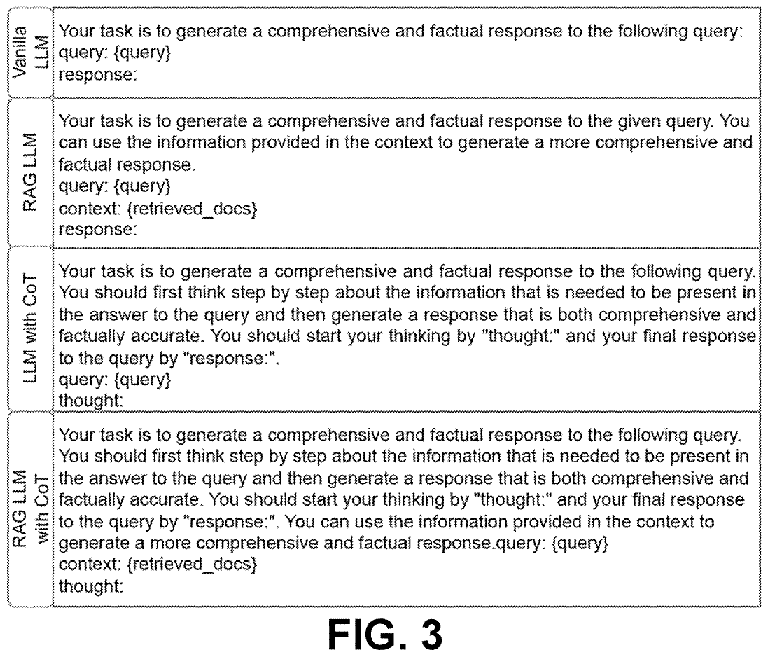

Baselines. A variety of baseline LLMs of different sizes were leveraged, both open-source and proprietary, with and without retrieval augmentation. The prompts used for the baselines are provided in FIG. 3. For retrieval augmentation, the same retriever P&R was used. For each baseline, the retrieval budget was set based on the performance on the validation set, ranging between 10 and 40, similar to the configuration used for P&R. These baselines include:

Open-Source: three open-source instruction-tuned LLMs were used as the backbone for baselines: LLama 3.2, with 1.2 billion parameters, Gemma V2, with 2.6 billion parameters, and Phi 3, with 3.8 billion parameters. For CoT models, only the final response was evaluated, and the intermediate reasoning steps were not assessed. For Best-of-N, N=16 outputs were generated for each LLM with a temperature of 0.7 using nucleus sampling, they were reranked using an off-the-shelf reranking model, and the top-ranked output was selected as the final response. Gemma v2 was trained using self-training with ICAT, in the same setting as P&R. The high-scoring outputs of the model were leveraged to train the model, enabling it to learn how to generate similar high-quality responses. This allows the potential improvements self-training can contribute to baseline models to be assessed. Finally, Maximal Marginal Relevance (MMR) was employed with λ=0.1 to rerank the top 1,000 documents retrieved by the retriever, investigating whether diverse retrieval results can enhance coverage of the generated responses.

Proprietary: For proprietary LLMs, two highly capable models with strong reasoning abilities were used: GPT-40-mini from OpenAI and Gemini 2 Flash from Google. These models inherently perform CoT, so they were not explicitly prompted for this. Additionally, due to the high cost associated with the Best-of-N approach, this method was not applied to the proprietary LLMs.

How P&R performed compared to baselines. P&R was compared against different baselines under different experimental conditions. The results of these experiments on the ANTIQUE dataset are presented in Table 1. These results demonstrate that P&R statistically significantly outperforms both open-source and proprietary LLMs on the ICAT-A metric, emphasizing its superior performance in generating complete and factual responses. Specifically, P&R achieves a 13.1% relative improvement over the best open-source baseline (row 26 in Table 1) and a 6.5% improvement over the best proprietary baseline (row 3). This highlights the effectiveness of P&R in improving factuality, coverage, and their aggregation (ICAT-A). The results in Table 1 suggest that RAG enhances the performance of LLMs on this task. Specifically, RAG helps generate more factual responses by incorporating relevant retrieved documents. However, it may lead to a reduction in coverage, as the retrieved documents tend to be more similar to one another, which limits the diversity of the generated content. Another interesting observation regarding the baselines is that the CoT approach tends to negatively affect the performance of LLMs in most cases on this task. It is believed this occurs because LLMs are typically trained to apply CoT for reasoning and mathematical tasks. However, the task of generating factual and complete responses is inherently different from these types of reasoning tasks. Thus, CoT may not be as effective for this task, leading to suboptimal performance in generating accurate and comprehensive outputs. In contrast, the Best-of-N approach generally enhances the performance of LLMs; however, it remains less effective for the Gemma 2 models. Moreover, self training proves to be the most effective strategy for training the baselines, though it still significantly lags behind P&R in terms of overall performance (row 26 vs 28). Given this, P&R shows the best and most promising results for this task. Finally, it was found that using MMR to diversify the retrieval results does not yield improvement in coverage and factuality of the generated responses in most cases; instead, it leads to a drop in performance (rows 18, 22, and 27).

TABLE 1
Performance of P&R compared to baselines on ANTIQUE. The † and ‡ show
statistically significant improvements over the best open-source and proprietary baselines,
respectively, as determined by a t-test (p < 0.05).

| | | | |
|---|---|---|---|
| Method | ICAT_{Coverage} | ICAT_{Factuality} | ICAT-A₁ |

Proprietary LLMs

| | | | |
|---|---|---|---|
| 1 Gemini 2.0 Flash | 0.7057 | 0.4488 | 0.5214 |
| 2 GPT-40 mini | 0.6551 | 0.4934 | 0.5376 |

Retrieval-Augmented Proprietary LLMs

| | | | |
|---|---|---|---|
| 3 RAG Gemini 2.0 Flash | 0.6499 | 0.5474 | 0.5640 |
| 4 RAG GPT-40 mini | 0.6439 | 0.5354 | 0.5576 |

Open-Source LLMs

| | | | |
|---|---|---|---|
| 5 Llama 3.2 | 0.3959 | 0.3201 | 0.3251 |
| 6 - w/ CoT | 0.3523 | 0.3444 | 0.3207 |
| 7 - w/ Best-of-N | 0.4521 | 0.3995 | 0.3924 |
| 8 Phi 3 mini | 0.5483 | 0.4433 | 0.4511 |
| 9 - w/ CoT | 0.4973 | 0.4219 | 0.4116 |
| 10 - w/ Best-of-N | 0.5489 | 0.4754 | 0.4741 |
| 11 Gemma v2 | 0.6064 | 0.4936 | 0.5143 |
| 12 - w/ CoT | 0.5257 | 0.4890 | 0.4659 |
| 13 - w/ Best-of-N | 0.5789 | 0.4787 | 0.4952 |
| 14 - w/ Self-Training | 0.5839 | 0.5268 | 0.5243 |

Retrieval-Augmented Open-Source LLMs

| | | | |
|---|---|---|---|
| 15 RAG Llama 3.2 | 0.3162 | 0.3295 | 0.2872 |
| 16 - w/ CoT | 0.3112 | 0.3243 | 0.2878 |
| 17 - w/ Best-of-N | 0.3564 | 0.3712 | 0.3363 |
| 18 - w/ MMR Reranking | 0.3005 | 0.2830 | 0.2751 |
| 19 RAG Phi 3 mini | 0.5369 | 0.5557 | 0.5022 |
| 20 - w/ CoT | 0.5173 | 0.5635 | 0.5071 |
| 21 - w/ Best-of-N | 0.5493 | 0.5386 | 0.5021 |
| 22 - w/ MMR Reranking | 0.5541 | 0.5656 | 0.4758 |
| 23 RAG Gemma v2 | 0.5457 | 0.5904 | 0.5256 |
| 24 - w/ CoT | 0.5028 | 0.5655 | 0.4880 |
| 25 - w/ Best-of-N | 0.4873 | 0.5809 | 0.4901 |
| 26 - w/ Self-Training | 0.5382 | 0.6054 | 0.5310 |
| 27 - w/ MMR Reranking | 0.5162 | 0.5977 | 0.5006 |
| 28 P&R | 0.6318^{†} | 0.6237^{†} | 0.6010^{†‡} |
| 29 - w/o Global | 0.6423^{†} | 0.6073^{†} | 0.5961^{†‡} |
| 30 - w/o Local | 0.6554^{†} | 0.6017^{†} | 0.5960^{†‡} |
| 31 - w/o Local & Global | 0.6543^{†} | 0.5808^{†} | 0.5832^{†‡} |
| 32 - w/o Local & Global | 0.6318^{†} | 0.5512 | 0.5556 |
| & Self-Training | | | |

How global and local exploitation affect performance. For this, global and local exploitation were evaluated separately, each using the same generation budget as P&R with both strategies combined (i.e., 16 generations). On the ANTIQUE dataset, experiments were conducted using only local exploitation, where a single plan is sampled greedily (with a temperature of τ=0.0) and refined through 16 editing steps, and only global exploration, where 16 plans are sampled using a higher temperature of τ=0.7 from the planner. The results are reported in Table 1 (row 29 for local exploitation only and row 30 for global exploration only). The findings indicate that while using either local or global exploration achieves nearly identical ICAT-A scores, both are suboptimal compared to P&R, which combines both approaches. However, both methods outperform the planning-only configurations with (row 31) and without (row 32) self-training. Additionally, they achieve statistically significant improvements over all baselines. These results highlight the effectiveness of global and local exploitation and demonstrate their complementary strengths when combined in P&R.

How planning alone with and without self-training affects performance. Here, the present disclosure focused on evaluating the planner without any global or local exploitation. Instead, a single plan was sampled greedily (temperature τ=0.0) to generate responses. Both the zero-shot planner and the self-trained planner were tested under these conditions. The results, shown in Table 1 for the ANTIQUE dataset, indicate that the self-trained planner (row 31) alone is suboptimal compared to P&R, but it achieves a 4.9% relative improvement on the ICAT-A metric compared to the zero-shot planner (row 32). This demonstrates the effectiveness of self-training in improving the planner's ability to generate better plans. Interestingly, the zero-shot planner (row 32) also outperforms the best-performing open-source baseline (row 26) with a 4.6% relative improvement, showing the value of planning even without prior training or exploration. To explore this further, P&R without the self-trained planner, local exploitation, and global exploration was compared to the best RAG baseline on the TREC dataset, which does not include a training set. Since the TREC dataset includes human annotations for subtopics that need to be addressed for each query, all variations of the ICAT metric on this dataset were reported. As reported in Table 2, P&R with a zero-shot planner and no exploration achieves a statistically significant improvement over the baselines, with a 9.4%, 36.3%, and 15.4% relative gain on ICAT-M, ICAT-S, and ICAT-A metrics, respectively. These findings highlight that this method can significantly improve performance compared to the best baseline across different levels of annotated data availability.

TABLE 2
Performance of P&R without self-training and exploration compared
to RAG baseline on TREC using different variations of ICAT metric.

| | | Manual | | Semi-Automatic | | Automatic | |
|---|---|---|---|---|---|---|---|
| Metric | Factuality | Coverage | ICAT-M₁ | Coverage | ICAT-S₁ | Coverage | ICAT-A₁ |
| RAG Gemma | 0.6720 | 0.2980 | 0.3203 | 0.1970 | 0.2294 | 0.5079 | 0.5148 |
| v2 | | | | | | | |
| P&R (w/o | 0.6325 | 0.3523^{†} | 0.3507^{†} | 0.2819^{†} | 0.3129^{†} | 0.6665^{†} | 0.5943^{†} |
| self-training & | | | | | | | |
| exploration) | | | | | | | |

The ^{†}shows statistically significant improvements over the baseline using t-test (p < 0.05).

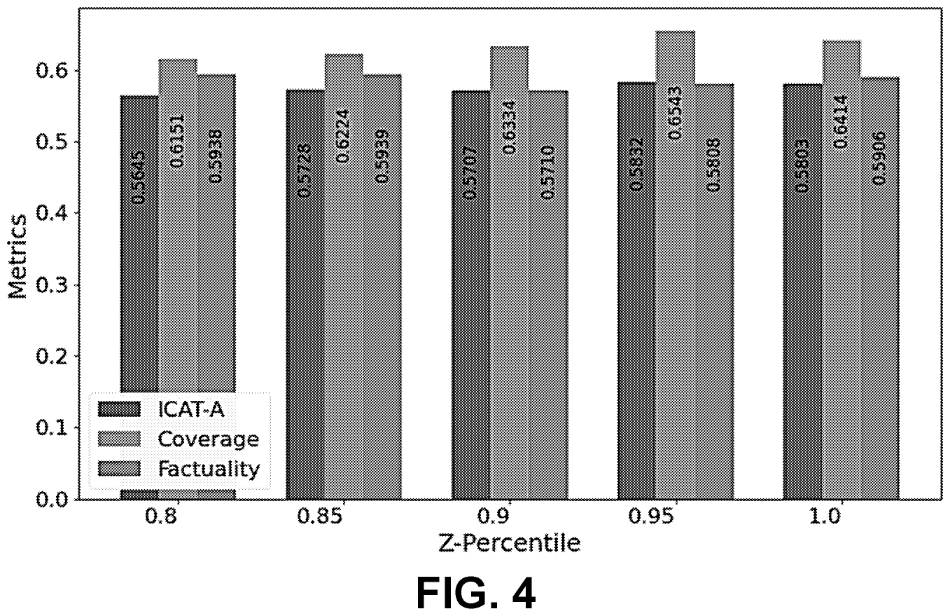

How planner's self-training threshold affects performance. An important hyperparameter in the proposed self-training approach for training the planner is the top Z-Percentile of the generated plans to be used for training. To investigate this, the model was trained using different values for Z and the planner was evaluated with them. In this experiment on the ANTIQUE dataset, a single plan was sampled greedily (temperature τ=0.0) and a response was produced. The results, shown in FIG. 4, indicate that as Z increases, the results improve, as it implies that the model is trained on higher quality outputs. The best performance was observed to occur at Z=0.95. However, setting Z=1, which means only the output with highest score being selected for training, leads to missing high quality outputs that could aid training. Therefore, optimizing this hyperparameter is important for achieving optimal results.

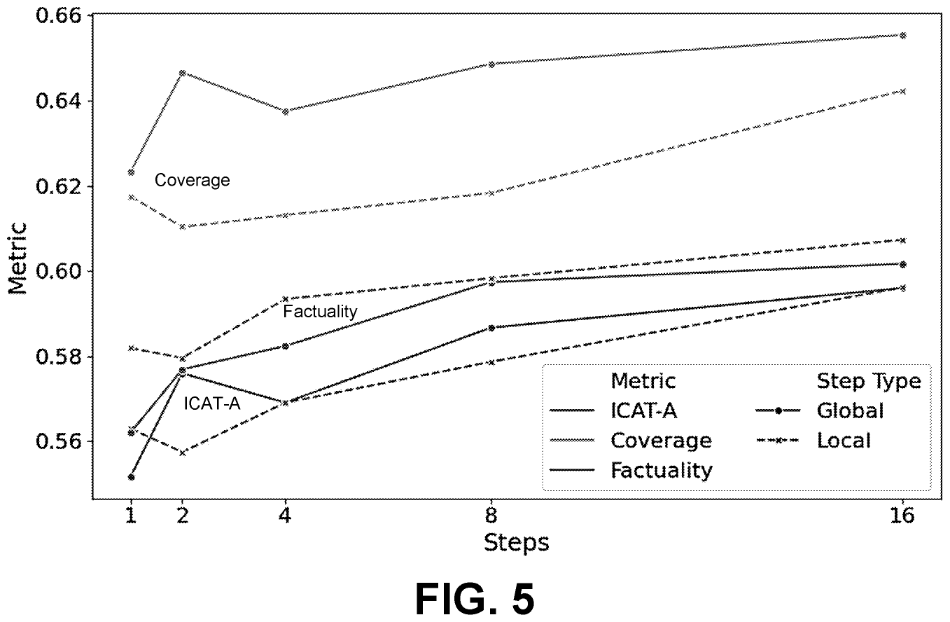

How global and local exploitation budget affect performance. To separately study the impact of local and global exploration steps, experiments were conducted on the ANTIQUE dataset using only local exploitation with a single plan sampled greedily (with a temperature of τ=0.0) and edited N times, and only global exploration with N plans sampled using a higher temperature of τ=0.7 from the planner. The results of this experiment are shown in FIG. 5. The results suggest that increasing the number of local and global exploration steps leads to improvements across all metrics, with the ICAT-A metric being nearly identical for both approaches with 16 generated outputs. However, it can be observed that increasing the number of global plans results in higher coverage, while increasing local exploitation steps leads to higher factuality. This observation indicates that sampling multiple plans produces outputs that cover more topics, but may lack factual accuracy. In contrast, sampling a single plan and applying multiple local exploitations and editing steps results in lower coverage but higher factual accuracy. Given this, it was shown that the primary contribution of global exploration is to enhance coverage, while the main contribution of local exploitation is to improve factuality.

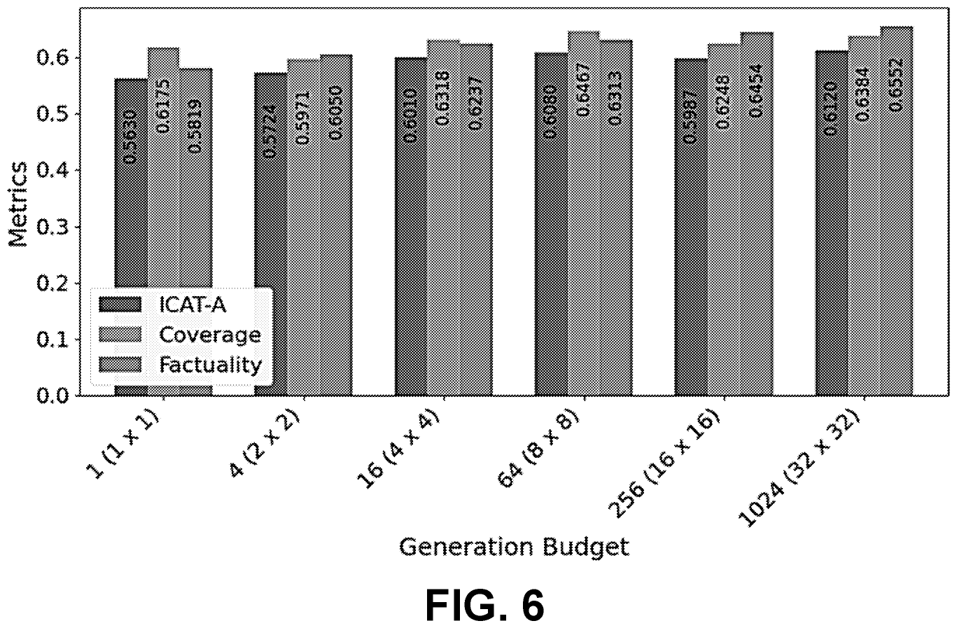

How exploration budgets affect performance. In this experiment on the ANTIQUE dataset, the performance of the approach described herein was evaluated under different exploration budgets: 1, 4, 16, 64, 256, and 1024 responses per input, where the budget is allocated equally to global and local exploitation. The results are visualized in FIG. 6, illustrating the impact of increasing the exploration budget on the performance of P&R. The results indicate that increasing the exploration budget leads to improved performance on the ICAT-A metric. A general trend of improvement in topic coverage is also observed, though with some fluctuations. In contrast, factuality shows a consistent increase as the budget grows. These findings suggest that higher exploration budgets enhance both factuality and topic coverage, with a particularly pronounced effect on factuality.

How P&R aligns with human preferences. 50 queries were randomly selected from the ANTIQUE test set and generated outputs using P&R and the best-performing open-source baseline from Table 1, RAG Gemma 2 w/ Self-Training. This baseline was used not only due to its strong performance, but also due to the fact that it uses the same LLM as P&R, for a fair comparison. Two human annotators evaluated the outputs based on three criteria: coverage of topics related to the input, factual accuracy of the generated responses, and overall quality. The inter-annotator agreement, measured using Cohen's κ, was 0.6189, indicating substantial agreement. The results are presented in Table 3. For coverage, annotators preferred P&R 64% of the time, compared to 26% for the baseline. For factuality, the outputs of both models were rated equally in 56% of cases, but in the remaining instances, P&R was preferred 35% of the time, while the baseline was chosen in only 9% of cases. Overall, P&R was selected as the preferred output in 63% of cases, compared to 29% for the baseline. These findings indicate that P&R aligns more closely with human preferences and produces higher-quality outputs.

TABLE 3
Human alignment comparison of P&R and RAG Gemma 2 with
Self-Training (best-performing baseline).

| Winner | Coverage (%) | Factuality (%) | Overall (%) |
|---|---|---|---|
| P&R | 64 | 35 | 63 |
| Baseline | 26 | 9 | 29 |
| Tie | 10 | 56 | 8 |

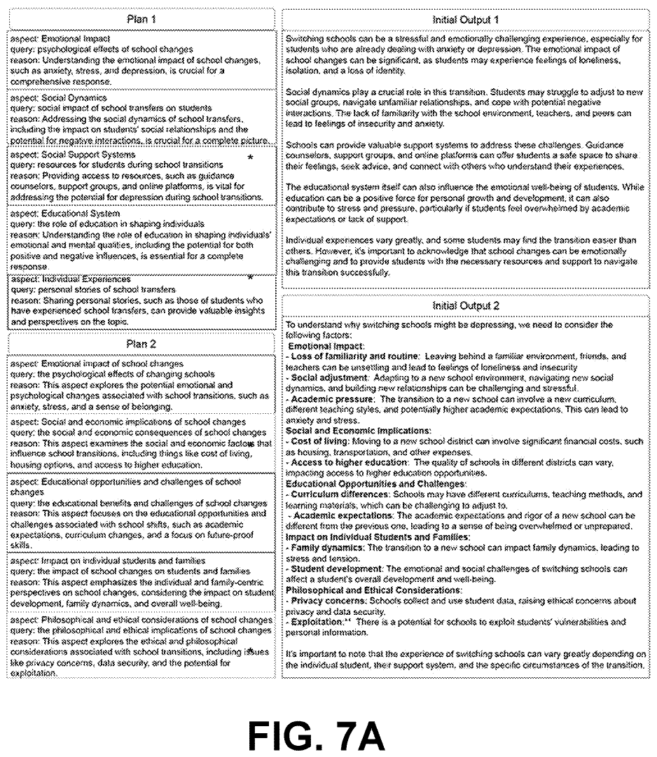

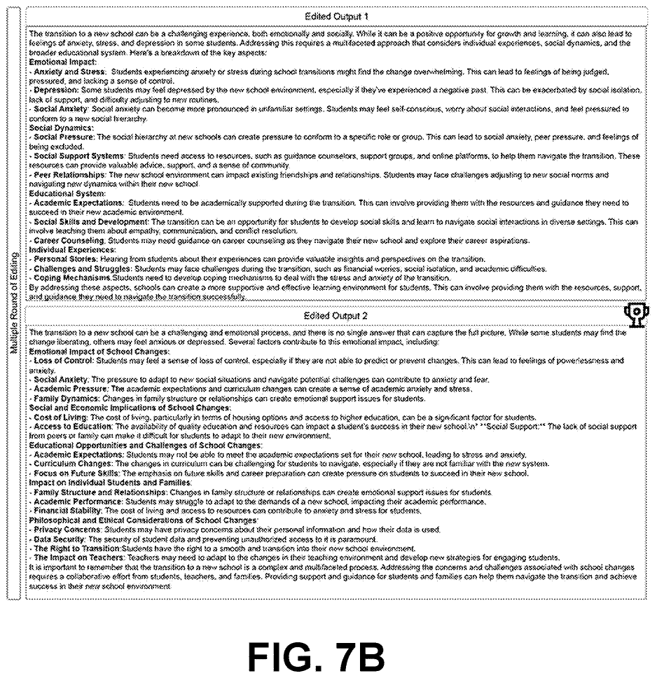

To provide a clearer understanding of how P&R works, an output example for a query from the ANTIQUE dataset is presented in FIGS. 7A-7B. Here, two plans were generated for global exploration, and for local exploitation, the responses were iteratively edited up to a maximum of 32 steps. FIG. 7A shows generated plans and initial outputs and FIG. 7B shows edited outputs. The aspects that differ between the two plans are indicated with (*) symbols. The selected response is labeled “Edited Output 2.” As illustrated in FIG. 7A, the two plans share several steps in addressing the query while also considering unique aspects (unique aspects are highlighted in different colors, and shared steps are shown in the same color). For instance, second plan emphasizes the economic, philosophical, and ethical reasons behind depression following a school change, whereas the first plan focuses on mentioning individual experiences, examples, and social groups that can help alleviate such challenges. This difference in the plans resulted in two distinct initial responses in terms of both content and style. Next, the initial generated responses are refined by the editing model over multiple steps to produce the edited outputs depicted in FIG. 7B. An interesting observation is that the edited responses exhibit greater depth in categorizing various aspects and provide more detailed and structured explanations. This structuring is particularly noticeable in the first output. Initially, the first response was presented as paragraphs without utilizing markdown formatting or hierarchical organization for different aspects. However, the edited output introduces markdown elements and restructures the response, enhancing its coverage and factuality. Finally, the reward model selected the second edited output as the final response to the question. This choice reflects its superior coverage and factual accuracy, as evidenced by its ability to address a broader range of aspects while maintaining a high degree of factual correctness.

According to various embodiments of the present disclosure described herein, P&R can improve the factuality and coverage of generated responses by LLMs. P&R can begin by generating a diverse set of plans for responding to a user prompt and can retrieve documents from a knowledge source to gather the necessary information for executing each plan. It can then generate a response for each plan and iteratively refine the response to enhance their factuality and comprehensiveness. Finally, a reward model can select the most factual and complete response from the set of generated proposals. Experiments on the ANTIQUE and TREC datasets demonstrated that P&R significantly outperforms both open-source and proprietary baselines, achieving up to a 13.1% improvement over open-source models and a 6.5% improvement over proprietary models. Furthermore, human evaluations reveal that P&R has substantially higher agreement with human preferences compared to baselines.

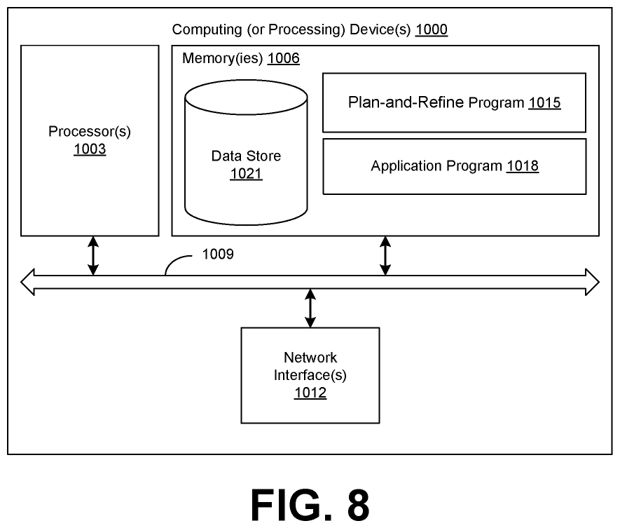

FIG. 8 is a schematic diagram illustrating an example of a computing (or processing) device 1000 that can be used for the Plan-and-Refine framework or other applications, in accordance with various embodiments of the present disclosure. The computing (or processing) device 1000 can comprise one or more computing/processing devices such as, e.g., a smartphone, tablet, computer, controller, etc. The computing (or processing) device 1000 can include processing circuitry comprising at least one processor circuit, for example, having a processor 1003 and a memory 1006, both of which are coupled to a local interface 1009. To this end, each computing (or processing) device 1000 may comprise, for example, at least one server computer or like device, which can be utilized locally or in a cloud-based environment or (spatially) distributed environment. The local interface 1009 may comprise, for example, a data bus with an accompanying address/control bus or other bus structure as can be appreciated.

In some embodiments, the computing (or processing) device 1000 can include one or more network interfaces 1012 for communication with various devices and systems. The network interface 1012 may comprise, for example, a wireless transmitter, a wireless transceiver, and/or a wireless receiver. The network interface 1012 can communicate to a remote computing/processing device or other components using a Bluetooth, WiFi, or other appropriate wireless protocol. As one skilled in the art can appreciate, other wireless or optical protocols may be used in the various embodiments of the present disclosure. The network interface 1012 can also be configured for communications through wired connections.

Stored in the memory 1006 are both data and several components that are executable by the processor(s) 1003. In particular, stored in the memory 1006 and executable by the processor 1003 can be a Plan-and-Refine application 1015 which can utilize the most significant cell methodology as disclosed herein, and potentially other applications 1018. In this respect, the term “executable” means a program file that is in a form that can ultimately be run by the processor(s) 1003. Also stored in the memory 1006 may be a data store 1021 and other data. In addition, an operating system may be stored in the memory 1006 and executable by the processor(s) 1003. It is understood that there may be other applications that are stored in the memory 1006 and are executable by the processor(s) 1003 as can be appreciated.

Examples of executable programs may be, for example, a compiled program that can be translated into machine code in a format that can be loaded into a random access portion of the memory 1006 and run by the processor(s) 1003, source code that may be expressed in proper format such as object code that is capable of being loaded into a random access portion of the memory 1006 and executed by the processor(s) 1003, or source code that may be interpreted by another executable program to generate instructions in a random access portion of the memory 1006 to be executed by the processor(s) 1003, etc. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, B#, Rust, Lua, Verilog, MATLAB/Simulink, Go, Assembly, or one or more other embedded or general purpose programming languages.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), non-volatile random access memory (NVRAM), synchronous dynamic random access memory (SDRAM), high-bandwidth memory (HBM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores, and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, ultrasound or other devices. The processor 1003 may be of electrical or of some other available construction.

Although the Plan-and-Refine application 1015, and other various applications 1018 described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the Plan-and-Refine application 1015, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, optical discs, or crystal or holographic storage. Also, the computer-readable medium may be a random access memory (RAM) including, for example, static random access memory (SRAM) and dynamic random access memory (DRAM), non-volatile random access memory (NVRAM), synchronous dynamic random access memory (SDRAM), high-bandwidth memory (HBM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the human-robotic mimetic haptic control application 1015, may be implemented and structured in a variety of ways. For example, one or more applications described may be implemented as modules or components of a single application. For example, the human-robotic mimetic haptic control application 1015 can include a wide range of modules such as, e.g., an initial model or other modules that can provide specific functionality for the disclosed methodology. Further, one or more applications described herein may be executed in shared or separate computing/processing devices or a combination thereof. For example, a plurality of the applications described herein may execute in the same computing (or processing) device 1000, or in multiple computing/processing devices in the same computing environment. To this end, each computing (or processing) device 1000 may comprise, for example, at least one server computer or like device, which can be utilized locally or in a cloud-based environment or (spatially) distributed environment.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for retrieval augmentation in text generation, comprising:
generating, by a computing device, a set of global exploration plans, each global exploration plan comprising a list of query aspects for creating a response to a query and a corresponding query formulation of each query aspect for retrieving relevant content;
retrieving, by the computing device, information based upon each of the set of global exploration plans; and
generating, by the computing device, a detailed response to the query by refining the retrieved information, the accuracy of the detailed response based upon evaluation by a trained reward model, the detailed response rendered for display.

2. The method of claim 1, wherein the retrieved information is iteratively refined to generate the detailed response.

3. The method of claim 1, wherein the reward model is trained to select a most factual and complete response.

4. The method of claim 1, wherein the set of global exploration plans includes randomness in its sampling.

5. The method of claim 1, wherein each global exploration plan is assigned to an LLM for retrieving information based upon the assigned global exploration plan.

6. The method of claim 5, wherein global exploration plan generates a plurality of outputs.

7. The method of claim 1, wherein each global exploration plan comprises a rationale about why each query aspect is important for ensuring a complete and factual response to the query.

8. A system for retrieval augmentation in text generation, comprising:
a computing device comprising a processor and memory storing code that when executed by the processor causes the computing device to at least:
generate a set of global exploration plans, each global exploration plan comprising a list of query aspects for creating a response to a query and a corresponding query formulation of each query aspect for retrieving relevant content;
retrieve information based upon each of the set of global exploration plans; and
generate a detailed response to the query by refining the retrieved information, the accuracy of the detailed response based upon evaluation by a trained reward model, the detailed response rendered for display.

9. The system of claim 8, wherein the retrieved information is iteratively refined to generate the detailed response.

10. The system of claim 8, wherein the reward model is trained to select a most factual and complete response.

11. The system of claim 8, wherein the set of global exploration plans includes randomness in its sampling.

12. The system of claim 8, wherein each global exploration plan is assigned to an LLM for retrieving information based upon the assigned global exploration plan.

13. The system of claim 12, wherein global exploration plan generates a plurality of outputs.

14. The system of claim 8, wherein each global exploration plan comprises a rationale about why each query aspect is important for ensuring a complete and factual response to the query.

15. A non-transitory computer readable medium comprising code that when executed by a processor of a computing device:
generates a set of global exploration plans, each global exploration plan comprising a list of query aspects for creating a response to a query and a corresponding query formulation of each query aspect for retrieving relevant content;
retrieves information based upon each of the set of global exploration plans; and
generates a detailed response to the query by refining the retrieved information, the accuracy of the detailed response based upon evaluation by a trained reward model, the detailed response rendered for display.

16. The non-transitory computer readable medium of claim 15, wherein the retrieved information is iteratively refined to generate the detailed response.

17. The non-transitory computer readable medium of claim 15, wherein the set of global exploration plans includes randomness in its sampling.

18. The non-transitory computer readable medium of claim 15, wherein each global exploration plan is assigned to an LLM for retrieving information based upon the assigned global exploration plan.

19. The non-transitory computer readable medium of claim 18, wherein global exploration plan generates a plurality of outputs.

20. The non-transitory computer readable medium of claim 15, wherein each global exploration plan comprises a rationale about why each query aspect is important for ensuring a complete and factual response to the query.
